(19) United States
(12) Patent Application Publication
(10) Pub. No.: US 2007/0132375 A1
(43) Pub. Date: Jun. 14, 2007

(54) Electronic device comprising a protective barrier layer stack

(76) Inventors: Peter Klaus Bachmann, Wurselen (DE); Volker Van Elsbergen, Aachen (DE); Peter Janiel, Wurselen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/578,644

(22) PCT Filed: Nov. 4, 2004
(86) PCT No.: PCT/IB04/52306

§ 371 Date: May 9, 2006

(30) Foreign Application Priority Data
Nov. 13, 2003 (EP) 03 104 189.0

(51) Int. Cl. H01J 1/62

(52) U.S. Cl. 313/505; 313/506

(57) ABSTRACT

In an electronic device comprising a protective barrier layer stack comprising a first barrier layer of a first amorphous carbon modification and a second barrier layer of a second amorphous carbon modification, the protective barrier layer stack has higher densities, better adhesion, and more flexibility than a single barrier layer of comparable thickness and composition.

The invention relates to an electronic device, comprising a protective barrier layer stack. The invention relates especially to an electroluminescent device comprising an electroluminescent diode and a protective barrier layer stack.

The invention relates more especially to an organic electroluminescent device (OLED) comprising an organic electroluminescent diode and a protective barrier layer stack.

Light-emitting diodes in accordance with the state of the art customarily are inorganic semiconductor diodes, i.e. diodes whose emitter material is an inorganic semiconductor, for example ZnS, silicon, germanium, or a III-V semiconductor such as InP, GaAs, GaAIAs, GaP, or GaN with suitable dopants.

As a result of the availability of semi conductive, organic, conjugated polymers and the detection that they are suitable for use in the manufacture of light-emitting components, persons skilled in the art all over the world embarked upon the development of organic electroluminescent diodes and, based upon said organic electroluminescent diodes, the development of displays and lamps.

Unlike inorganic LEDs, the application of which in displays having a comparatively high resolution is subject to certain conditions and involves high costs, organic electroluminescent diodes are deemed to have an enormous potential for small, easy-to-use displays.

Unlike liquid crystal displays, organic electroluminescent displays also have the advantage that they are luminescent and hence do not require an additional backlighting source.

As a result, said organic electroluminescent display devices are employed in applications where luminescent display devices with a low supply voltage and low power dissipation are required. Said applications include, in particular, displays for mobile use such as cellular phones and organizers, or applications in automobiles, i.e. from radios to navigation systems.

The organic electroluminescent device according to the invention is also useful for general illumination purposes.

Organic light-emitting devices (OLEDs) use an organic or polymeric material that emits light for displays in electronic devices and lamps. An organic or polymeric material that is light-emissive may be sandwiched between row and column electrodes. When a potential is applied to the light-emitting material, it emits light of a particular wavelength. The emitted light passes through the column electrode, which may be transparent in some embodiments.

A protection of the active materials of the device from environmental conditions has been found to be necessary to ensure good performance. In particular, materials sometimes used in the electrodes (e.g., calcium, magnesium, etc.) are known to be extremely sensitive to oxygen and moisture in ambient air. The electroactive organic or polymeric layers also need to be protected from moisture because charge injection (which takes place via radical species) can easily be impeded by the presence of oxygen and/or water. Various protective schemes have accordingly been proposed in order to seal organic electroluminescent display devices so as to protect them from moisture and detrimental gases.

For example, US 20030025448 describes an organic electroluminescent display device comprising a front electrode member, a counter electrode member, an organic electroluminescent member arranged between the front electrode member and the counter electrode member, and a protective layer of an amorphous carbon modification, by means of which the organic electroluminescent display device is sealed in a gastight and moisture-proof manner.

It has been found that the process of coating a protective barrier layer of an amorphous carbon especially over large areas presents many technical challenges. Issues that would typically need to be addressed in scaling up production to larger sizes include, for example, pinholes, CTE mismatches during thermal treatment, and imperfect adhesion to organic and inorganic interfaces.

Thin protective layers of an amorphous carbon modification are susceptible to pinholes.

If the film thickness of the layers is increased, internal stresses in the coated film are greatly increased, so that flaking exfoliation is liable to occur.

So, despite the many barrier layer materials that are currently employed in the art to protect the electrodes and luminescent materials in an organic electroluminescent device, there is still a continued need to provide a protective barrier material for use in organic electroluminescent devices.

It is a general object of the invention to provide an electronic device comprising a mechanically and chemically stable protective barrier material that serves as a reliable diffusion barrier to moisture and detrimental gases and that allows plastic deformation.

In accordance with the present invention, this object is achieved by an electronic device comprising a protective barrier layer stack comprising a first barrier layer of a first amorphous carbon modification and a second barrier layer of a second amorphous carbon modification.

The present invention is based on the observation that a protective barrier layer stack comprising a first barrier layer of a first amorphous carbon modification and a second barrier layer of a second amorphous carbon modification has higher densities, better adhesion, and more flexibility than a single barrier layer of comparable thickness and composition.

The improved mechanical properties may be due to the ability of the interface between the two barrier layers to relieve stress. This stress relief occurs if the interface provides a slide plane, is plastic, or may delaminate locally.

Said protective barrier layer stack forms an excellent barrier against the penetration of water vapor and other contaminating or corrosive substances, and it is insensitive to mechanical deformation, crack formation, and scratches.

The invention is especially useful for organic electroluminescent devices that are prone to degradation by moisture and harmful gases.

In the present invention, the first and the second amorphous carbon modification may be selected from the group of amorphous carbon modifications comprising amorphous carbon, tetrahedral amorphous carbon, hydrogenated amorphous carbon, tetrahedral hydrogenated amorphous carbon, diamond-like carbon, and glassy carbon.

A step in the composition of the first and the second barrier layer interrupts the film thickness and results in discontinuous stacks, preventing crack propagation across the entire stack thickness.

In the present invention, the first and the second amorphous carbon modification may also be selected from the group of doped amorphous carbon modifications, wherein the dopant is selected from the group of boron, silicon, nitrogen, phosphorus, oxygen, and fluorine.

The structure consists of a multiplicity of chemically distinct layers. Such chemical differences may be useful and may contribute to improved properties of the materials.

In one embodiment of the present invention, at least one of the first and second barrier layers comprising a first or second amorphous carbon modification is selected from the barrier layers having a plasmon energy >27 eV. Such layers provide improved protection and enhance the lifetime of the electronic device.

In one embodiment of the present invention, the first and the second amorphous carbon modification are selected from the group of amorphous carbon modifications having a refractive index n>1.8.

In another embodiment of the present invention, the first and the second amorphous carbon modification are selected from the group of amorphous carbon modifications having a refractive index n>2.0.

In one embodiment of the present invention, the first barrier layer of a first amorphous carbon modification has a first refractive index and the second barrier layer of a second amorphous carbon modification has a second refractive index higher than the first refractive index.

Such a combination of layers distinguished by their coefficients of refraction may be useful and may. contribute to improved properties of the materials.

In another embodiment of the present invention, the first barrier layer of a first amorphous carbon modification has a first refractive index n1>1.8 and the second barrier layer of a second amorphous carbon modification has a second refractive index n2>2.0.

In a further embodiment of the present invention, the protective barrier layer stack comprises an interlayer between the first barrier layer of a first amorphous carbon modification and a second barrier layer of a second amorphous carbon modification.

Preferably, the interlayer comprises a polymer selected from the group of polymers such as parylenes, benzocyclobutanes, polyimides, fluorinated polyimides, poly(arylene ethers), poly(naphthalenes), poly(norbones), fluoropolymeres (e.g. PTFE), chlorofluoropolymeres(PCFP), or hydrocarbons.

In a preferred embodiment of the invention, the interlayer comprises a polymer selected from the group of polymers such as parylenes, benzocyclobutanes, polyimides, fluorinated polyimides, poly(arylene ethers), poly(naphthalenes), poly(norbones), fluoropolymeres (e.g. PTFE), chlorofluoropolymeres(PCFP), or hydrocarbons, and all amorphous carbon modifications are selected from the group of amorphous carbon modification comprising at least 10% hydrogen bonded to the carbon atoms of the amorphous carbon modification.

Such a protective barrier layer stack is defined as an all-organic matter barrier layer stack.

In another embodiment of the present invention, the protective barrier layer stack comprises an adhesion layer between the first barrier layer of a first amorphous carbon modification and the organic electroluminescent diode.

In another embodiment of the present invention, the protective barrier layer stack comprises a top layer lying on and in contact with the second barrier of a second carbon modification.

For the present invention, it is preferred that the thickness of the barrier layer stack be greater than or equal to 30 nm.

Even if the thickness of the carbon layer stack is set to be greater than 30 nm, the increase in the internal stresses in the amorphous carbon layer is small, and the amorphous carbon barrier layer stack can maintain an excellent adhesion strength with respect to the organic electroluminescent diode.

The invention also relates to a method of manufacturing an electronic device comprising a protective barrier layer stack comprising a first barrier layer of a first amorphous carbon modification and a second barrier layer of a second amorphous carbon modification, in which the first and the second protective barrier layer are deposited from the gas phase.

In accordance with a preferred embodiment of the invention, the protective layer is deposited by means of a radio-frequency plasma CVD process.

It is particularly preferred that the operating point of the deposition from the gas phase lies in the kinetically controlled range.

It is an advantage of the present invention that the protective barrier layer stack may be deposited by means of the same deposition methods as the active layers and the electrodes. In this manner, it is possible to provide the first encapsulation process in situ, i.e. in the same place where the device is fabricated, avoiding manipulations and passages that might introduce oxygen, water, or other contaminants.

These and other aspects of the invention are apparent from and will be elucidated with reference to the embodiments described hereinafter.

An electronic device in accordance with the invention comprises a protective barrier layer stack comprising a first barrier layer of a first amorphous carbon modification and a second barrier layer of a second amorphous carbon modification.

An electronic device according to the invention may preferably be any electroluminescent device, such as an organic electroluminescent device OLED or an inorganic-organic electroluminescent device LED, comprising GaN, GaAS, AlGaN, or InP.

The invention is also very useful for organic thin-film transistors (OTFT) used in Plastic Electronics.

Within this invention “organic electroluminescent device” (OLED) is used as a generic name for electroluminescent devices comprising an organic electroluminescent diode with an active electroluminescent layer containing materials selected from the group of organic, small organic, and polymeric electroluminescent materials. Such devices are used in displays, light tiles, and large-area light emitters.

Devices made with polymeric light-emitting materials are occasionally also referred to as polymeric light-emitting devices (PLED), devices made with small organic molecules as SMOLEDS.

Such an organic electroluminescent diode typically comprises an arrangement of superposed and partly juxtaposed individual layers. To form such an arrangement of layers, use can be made of all layer structures and materials known to persons skilled in the art. Customarily, the OLEDs comprise an electroluminescent layer arranged between a positive electrode as the front electrode and a negative electrode as the counter electrode, one or both electrodes being possibly transparent and/or segmented. In addition, one or more electron-injection layers and/or electron-transport layers may be arranged between the electroluminescent layer and the positive electrode. Likewise, one or more hole-injection layers and/or hole-transport layers may be arranged between the electroluminescent layer and the negative electrode.

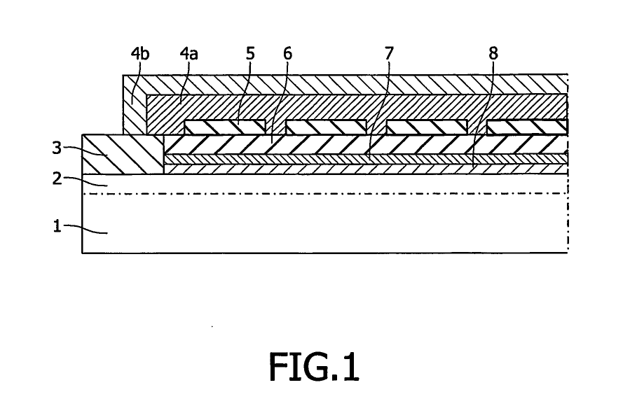

FIG. 1 is a cross-sectional view of an OLED structure in accordance with an embodiment of the present invention useful as a display device.

Said organic electroluminescent display device comprises a first electrode 8 of ITO with contact terminals 3, an electroluminescent layer 7 of PDOT, a second electroluminescent layer 6 of PPV, and a second electrode of Al 5. The organic electroluminescent display device is additionally covered with a protective barrier layer stack comprising a first barrier layer of amorphous carbon 4a and a second protective barrier layer of amorphous carbon 4b.

Preferably, the display device is fastened to an optically transparent substrate 1 by means of a layer of SiO₂ 2.

This arrangement of layers may be provided on a substrate of glass, quartz, ceramic, synthetic resin, or a transparent flexible plastic film. Suitable synthetic resins are, for example, polyimides, polyethyleneterephtalate and polytetrafluoroethylene. The invention is also useful for TOLEDs, wherein light is emitted on the rear side of the device.

The electroluminescent layer is arranged between two electrode layers.

The negative electrode supplies electrons, which combine with the holes in the organic electroluminescent layer originating from the positive electrode so as to form excitons, emitting photons during the recombination process.

At least one of the electrode layers should be transparent or at least translucent. Customarily, the positive electrode is made of a non-stoichiometric or doped tin oxide, for example ITO, or of a metal with a high work function, for example gold or silver. These electrode materials can be readily used to form transparent layers. Particularly ITO is suitable for this purpose as it is highly electroconductive and transparent.

Alternatively, use may be made of a layer of a conductive polyaniline or poly-3,4-ethylenedioxythiophen, whether or not in combination with an ITO layer as the transparent positive electrode.

The negative electrode, which injects electrons into the organic electroluminescent layer, should have a low work function. Materials that are suitable for use. as the negative electrode are, for example, indium, aluminum, calcium, barium, and magnesium. If the negative electrode is made from reactive barium, it is advisable to cover this electrode layer with a further protective layer of an epoxy resin or an inert metal. These layers have the advantage that their reflectivity is lower than that of metal layers.

It has been found that aromatic, conjugated ladder polymers of the poly(paraphenylene)-type (LPPP), which chemically resemble oligophenylene or polyphenylene, are particularly suitable as organic electroluminescent components for use in organic LEDs. LPPPs exhibit a continuous chain of conjugated double bonds. Particularly suitable are, for example, soluble polyphenylene ethylene vinylene and soluble polythiophene, in particular polyphenylenevinylene, which are further substituted at the phenyl ring, in the 2^{nd} and 5^{th} position, with alkyl or alkoxy residues. Such polymers are readily processable and yield layers having an amorphous structure. Examples of suitable polyphenylene vinyls are poly(2-methyl-5-(n-dodecyl)-p-phenylenevinylene, poly(2-methyl-5-(3,5,dimethyloctyl)-p-phenylenevinylene, poly(2-methyl-5-(4,6,6,-trimethylheptyl)-p-phenylenevinylene, poly(2-methoxy-5-dodecyloxy-p-phenylenevinylene, and poly(2-methoxy-5-(ethylhexyloxy)-phenylenevinylene (MEH-PPV).

Devices comprising two different electroluminescent layers clearly outperform organic, electroluminescent devices having only one electroluminescent layer. One layer effectively transports holes, for example PPV, and one layer effectively transports electrons, for example oxadiazole. This enables holes and electrons to recombine more readily.

Polyethylenedioxythiophene PEDOT and polyethylenedioxythiophene -polystyrenesulphonate PEDOT-SS are particularly advantageous for transporting positive charge carriers. For transporting positive charge carriers, use is very advantageously also made of 4,4′,4″-tris[N-(1-naphtyl)-N-phenyl-amino]-triphenylamine in combination with hydroxyquinoline aluminum-III-salt Alq3 as the emission and electron transport material.

As was noted above, the final display or lamp needs to be encapsulated to prevent oxygen and moisture from penetrating to the electrodes and light-emitting layers.

In accordance with the present invention, the organic electronic device also comprises a protective barrier layer stack comprising a first barrier layer of a first amorphous carbon modification and a second barrier layer of a second amorphous carbon modification.

Amorphous carbon modifications are defined as metastable, amorphous carbon materials comprising an amorphous carbon network which may contain nanocrystalline or microcrystalline phases.

As used in this application, “amorphous” denotes a randomly ordered non-crystalline material having no x-ray diffraction peaks.

At least some of the carbon atoms in amorphous carbon materials are bonded in chemical structures similar to that of diamond, wherein bonds are of the sp³ type. A substantial portion of the remainder of the bonds may be of the graphitic or sp² type. The bonds in the layer may also include some carbon-hydrogen (C—H) bonds.

Such carbon modifications comprise carbon modifications that are referred to as amorphous carbon (a-C), hydrogenated amorphous carbon (a-C:H), tetrahedral amorphous carbon (t-aC), tetrahedral hydrogenated amorphous carbon (t-aC:H) or, on account of the high mechanical hardness, diamond-like carbon (DLC) or glassy/vitreous carbon.

A-C:H denotes hydrogenated amorphous carbon. These materials can contain up to 50 atomic percents of hydrogen.

Highly tetrahedral amorphous carbon (ta-C) forms sp³ carbon-carbon bonds, and is a special form of diamond-like carbon (DLC).

“Diamond—like carbon” refers to an amorphous film or coating comprising approximately 50 to 90 atomic percents carbon and approximately 10 to 50 atomic percents hydrogen, and composed of approximately 50 to approximately 90% tetrahedral bonds.

Glass-like carbon is a type of carbon that in many characteristics is similar to glass. Glass-like carbon has a closed microporosity, is impermeable to gas, and has a hardness corresponding to that of glass.

Amorphous carbon modifications that comprise a substantial amount, e.g. 10 to 50 atomic percents of hydrogen bound to carbon atoms fulfill the general definition of “organic” matter rather than inorganic matter.

The amorphous carbon materials may also contain dopant atoms such as boron, nitrogen, phosphorus, oxygen, fluorine, silicon, and/or the like.

These amorphous modifications of carbon have particular physical properties that can be attributed to the simultaneous occurrence of tetrahedral bonding with sp³ hybridization and trigonal bonding with sp² hybridization in their structure.

As the relative amount of tetragonal and trigonal bonding can be influenced by the manufacturing methods, the physical parameters can be influenced too.

The provision of sp³ type bonds in a barrier layer serves to increase the hardness and scratch resistance of the layer comprising an amorphous carbon modification, while the graphitic sp² type bonds cause the layer to be more malleable.

Amorphous carbon layers may further be characterized by their refractive indices.

Materials with different refractive indices can be produced by a change in the deposition conditions, e.g. precursor gases, pressures, etc.

The device comprises a protective barrier stack comprising a first barrier layer of a first amorphous carbon modification and a second barrier layer of a second amorphous carbon modification adjacent to the organic electroluminescent diode. By “adjacent”, is meant next to, but not necessarily directly next to. There may be additional interposed layers. The barrier stack includes at least one first barrier layer and at least one second barrier layer.

As used herein, a “layer” of a given material includes a region of that material whose thickness is small compared to both its length and its width. Examples of layers include sheets, foils, films, laminations, coatings, and so forth. As used herein, a layer need not be planar, but may be bent, folded or otherwise contoured, for example so as to at least partially envelop another component.

The barrier layer stack may have a layer structure composed of a bi-layer or a tri-layer or may have a structure formed by lamination of a plurality of single layers.

For example, there may be adopted a bi-layer structure of one layer selected from the group of hard amorphous carbon modifications and a second layer selected from the group of a soft amorphous carbon modifications.

The synergistic interaction of a hard carbon layer and a lubricious carbon layer provides a long lived device coating.

Said protective barrier layer stack adheres well to the metals or alloys of the electrodes and levels the comparatively fissured surface of the organic electroluminescent device to a smooth, impervious surface.

There may also be adopted a tri-layer structure of two layers selected from the group of hard amorphous carbon modifications and a third interlayer selected from the group of soft amorphous carbon modifications. Especially advantageous results are achieved when the protective coating comprises a barrier layer of a triple coating comprising a hard microcrystalline tetragonal taC or taC:H carbon modification and a soft barrier interlayer of an amorphous trigonal aC or DLC-carbon modification.

There may be also adopted a laminar structure consisting of amorphous carbon. layers alternating with layers of either another or the same amorphous carbon modification, i.e. the protective barrier layer stack includes different layers with different sp³ carbon-carbon bond percentages.

Such a multilayer barrier layer stack system with varying compositions of the amorphous carbon modification at different layers thereof may be continuously formed by varying feedstock and/or precursor gas(es) used, and/or by varying the ion energy used in the deposition process.

In this embodiment, the individual amorphous carbon layers are relatively thin (about 5 to 20 nm, and in combination build up to a thicker barrier layer stack of a thickness ≧30 nm. The alternating layer structure reduces the mechanical stresses that would otherwise be a problem for a thick barrier layer assembly.

According to one embodiment of the invention, the composite barrier layer structure of an electronic device according to the invention comprises a first barrier layer of a first amorphous carbon modification and a second barrier layer of a second amorphous carbon modification, wherein either the first or the second amorphous carbon modification may be selected from the group of doped amorphous carbon modifications, wherein the dopant is selected from the group of boron, silicon, nitrogen, phosphorus, oxygen, and fluorine.

The structure comprising doped amorphous carbon modifications may be tailored to the requirements of the application. For example, the first layer may be enriched with silicon in order to maximize the adhesion to the substrate.

The second layer may be enriched with fluorine in order to maximize the hydrophobic characteristics of the protective barrier stack.

In another case, the protective barrier layer stack may comprise multiple layers of amorphous carbon materials with at least two different refractive indices. The layers of the present invention may be either a low refractive index layer with refractive index of n<1.8, e.g. 1.5, or a high refractive index layer with refractive index of n>1.8, e.g. 1.9 to 2.1.

Multilayer stacks with materials having gradations in refractive index in a predetermined pattern or profile as a finction of the thickness of the layer are preferred.

Gradation changes may be discontinuous or continuous, e.g. sinusoidal.

By sequencing such layers in a manner that creates continuous or discontinuous step changes in the refractive index, organic electroluminescent devices can be realized with reduced internal stresses and optimal barrier characteristics.

In one embodiment of the present invention, a multilayer barrier layer stack is used wherein the barrier layer stack optionally includes at least one polymer interlayer, preferably in a tri-layer stack, wherein the polymer interlayer is located between the first and the second barrier layer of an amorphous carbon modification.

The polymer of interlayers of the barrier stacks are preferably composed of a polymer such as parylenes, benzocyclobutanes, polyimides, fluorinated polyimides, poly(arylene ethers), poly(naphthalenes), poly(norbones), fluoropolymeres (e.g. PTFE), chlorofluoropolyrneres(PCFP), or a hydrocarbon.

Multilayer barrier layer stacks composed of layers consisting of amorphous carbon modifications with a substantial amount of hydrogen bound to the carbon atoms and a polymer interlayer are regarded as “all-organic” protective barrier layer stacks.

In another embodiment of the present invention, the protective barrier layer stack includes an adhesion layer adjacent to the electronic device and between the electronic device and the primary protective barrier layer.

The material of the adhesion layer maybe appropriately selected from any known suitable adhesion promoters, but preferably is a plasma polymerized organosilicon compound, polymethylmethacrylate (PMMA), polyvinylidene fluoride, or the like, deposited on the surface of the organic electroluminescent diode.

There may be additional overcoat top layers on top of the barrier stack, such as organic or inorganic layers, planarizing layers, transparent conductors, antireflective coatings, or other functional layers, as desired.

Optimum performance is obtained when the total barrier layer stack thickness is in a range of ≧30 nm, e.g. 2 micrometers to 10 micrometers, and the barrier layer thickness of each individual layer is in a range of 5 to 20 nm.

Since this first initial research into the deposition of amorphous carbon layers, a variety of different manufacturing techniques such as dc or RF plasma-assisted carbon vapor deposition, sputtering, and ion-beam sputtering have been utilized. Furthermore, a variety of carbon-bearing source materials, i.e. solid, liquid, or gaseous, have also been utilized in order to improve the parameters of the carbon layers.

The protective layer of an amorphous modification of carbon is preferably manufactured by deposition from the gas phase, i.e. by a PVD process such as sputtering and evaporation, and in particular by a CVD process. Suitable CVD processes include plasma CVD processes, ECR-plasma-CVD processes, DC-plasma-jet-CVD processes, filtered cathode arc deposition processes, cascaded arc-CVD-processes, microwave-plasma-CVD processes, and especially RF-plasma-CVD processes.

The preferred mode of ion-assisted plasma deposition amorphous carbon coating is ion-assisted capacitively coupled radio-frequency (RF) plasma deposition, as said process leads to a very high conformity of the deposition. In the case of a deposition process with ideal conformity, the rate at which the layers are formed at vertical surfaces is equal to that at horizontal surfaces, and a uniform step coverage is attained. The conformity of the deposition is favorably influenced if the operating point of the deposition from the gas phase lies in the kinetically controlled range. High temperatures also have a favorable effect on the conformity of the deposition; however, the deposition temperature is preferably below 250° C. As said temperature is insufficient for pyrolysis, the feed gas is additionally excited by a radio-frequency gas discharge and decomposed, so that it adheres to the surface of the organic electroluminescent device.

The surface to be coated is preferably moved with respect to the carbon source during the coating operation.

An appropriate reaction control enables layers of amorphous carbon having a high electrical resistance to be manufactured during the deposition from the gas phase. Layers having resistance values up to 10¹³Ω are possible. If the protective barrier layers are deposited from the gas phase, said protective barrier layers may be formed from different feed gases. Gaseous hydrocarbons are preferred, for example alkenes, i.e. saturated aliphatic hydrocarbons such as methane, ethane, and propane. Use is preferably made of methane. In addition, use may also be made of alkenes, i.e. unsaturated hydrocarbons such as ethane and propane, for example acetylene, cycloalkane, i.e. saturated cyclic hydrocarbons such as cyclohexane and, in the vapor state, aromatic hydrocarbons such as benzene or benzene derivatives. The hydrocarbons of the type mentioned above may be used individually or as a mixture. In addition, inert gases such as helium or argon may be added to the hydrocarbons.

The surface to be coated of the electronic device is advantageously shielded during the coating process by measures such as beam control, filters, etc. against the influence of UV radiation and ion bombardment taking place during the coating process.

As was noted above, by adjusting the deposition parameters in the process of the present invention, the physical parameters, such as hardness, density, and refractive index of the barrier layers can be varied continuously or discontinuously.

Primary process parameters, which control the physical parameters of the layers, are the energy of ions bombarding the surface during coating deposition and the feed gas chemistry.

Increasing the energetics of the deposition process causes the layer characteristics to change from tetrahedral sp² to trigonal sp³-bonded material and from a refractive index n<1.8 to a refractive index >1.8, e.g. 1.9 to 2.1.

The phrase “energetics of the deposition process,” is defined as the energy delivered to the coating surface divided by the deposition rate. Energy is delivered to the coating surface by substrate heating, impacting ions and fast neutral species, and radiated power from the plasma.

Feed gas chemistry influences the parameters in amorphous carbon materials made from pure hydrocarbon precursor feed gases at low deposition energy are soft and polymeric in nature.

As was noted above, the first and the second barrier layer cooperate to block the transport of oxygen, water, and any other harmful molecules from the exterior environment to the electronic device.

The device in accordance with the invention may further comprise optical filter members that suppress reflections within the device. These reflections develop, on the one hand, at the interfaces between the layers of the device, which layers have different refractive indices, and, on the other hand, at the metal cathode which acts as a metal mirror.

To suppress light reflection at the cathode, said cathode may be coated with an electroconductive, light-absorbing layer.

The device in accordance with the invention may additionally comprise devices that influence the electro-optical properties, such as UV filters, anti-reflex coatings, devices known as microcavities, such as color-conversion and color-correction filters.

In the drawing

FIG. 1 diagrammatically shows the structure of an organic electroluminescent device in accordance with the invention.

### LIST OF NUMERALS

1 optically transparent substrate
2 adhesive layer
3 contact terminals
4 barrier layer stack of amorphous carbon
4a first barrier layer of amorphous carbon modification
4b second barrier layer of amorphous carbon modification
5 second electrode
6 second electroluminescent layer
7 first electroluminescent layer
8 first electrode

1. An electronic device comprising a protective barrier layer stack comprising a first barrier layer of a first amorphous carbon modification and a second barrier layer of a second amorphous carbon modification.

2. An electronic device according to claim 1, wherein the electronic device is an organic electroluminescent device.

3. An electronic device according to claim 1, wherein the first and the second amorphous carbon modification are selected from the group of amorphous carbon modifications comprising amorphous carbon, tetrahedral amorphous carbon, hydrogenated amorphous carbon, tetrahedral hydrogenated amorphous carbon, diamond-like-carbon, and glassy carbon.

4. An electronic device according to claim 1, wherein the first and the second amorphous carbon modification are selected from the group of doped amorphous carbon modifications, wherein the dopant is selected from the group of boron, silicon, nitrogen, phosphorus, oxygen, and fluorine.

5. An electronic device according to claim 1, wherein at least one of the first and second barrier layers comprising a first or second amorphous carbon modification is selected from the barrier layers having a plasmon energy >27 eV.

6. An electronic device according to claim 1, wherein the first and the second amorphous carbon modification are selected from the group of amorphous carbon modifications having a refractive index n>1.8.

7. An electronic device according to claim 1, wherein the first and the second amorphous carbon modification are selected from the group of amorphous carbon modifications having a refractive index n>2.0.

8. An electronic device according to claim 1, wherein the first barrier layer of a first amorphous carbon modification has a first refractive index and the second barrier layer of a second amorphous carbon modification has a second refractive index higher than the first refractive index.

9. An electronic device according to claim 1, wherein the first barrier layer of a first amorphous carbon modification has a first refractive index n1>1.8 and the second barrier layer of a second amorphous carbon modification has a second refractive index n2>2.0.

10. An electronic device according to claim 1, comprising an interlayer between the first barrier layer of a first amorphous carbon modification and a second barrier layer of a second amorphous carbon modification.

11. An electronic device according to claim 6, wherein the interlayer comprises a polymer selected from the group of parylenes, benzocyclobutanes, polyimides, fluorinated polyimides, poly(arylene ethers), poly(naphthalenes), poly(norbones), fluoropolymeres (e.g. PTFE), chlorofluoropolymeres(PCFP), and hydrocarbons.

12. An electronic device according to claim 11, wherein all amorphous carbon modifications are selected from the group of amorphous carbon modification comprising at least 10% hydrogen bound to the carbon atoms.

13. An electronic device according to claim 1, comprising an adhesion layer between the first barrier layer of a first amorphous carbon modification and the electroluminescent diode.

14. An electronic device according to claim 1, comprising a top layer lying on and in contact with the second barrier of a second carbon modification.

15. An electronic device as claimed in claim 1, characterized in that the layer thickness of the barrier layer stack d≧30 nm.

16. A method of manufacturing an electronic device comprising an electroluminescent diode and a protective barrier layer stack comprising a first barrier layer of a first amorphous carbon modification and a second barrier layer of a second amorphous carbon modification, wherein the first and the second protective barrier layer are deposited from the gas phase.

17. A method of manufacturing an electronic device as claimed in claim 15, characterized in that the protective layer is deposited by means of a RF plasma CVD process.

18. A method of manufacturing an electroluminescent device as claimed in claim 15, characterized in that the operating point of the deposition from the gas phase lies in the kinetically controlled range.
